(19) United States
(12) Patent Application Publication
(10) Pub. No.: US 2009/0082057 A1
(43) Pub. Date: Mar. 26, 2009

(54) COGNITIVE RADIO TERMINAL DEVICE AND METHOD OF COMMUNICATING USING COGNITIVE RADIO

(75) Inventors: Hyo Sun HWANG, Seoul (KR); Sunghyun Choi, Seoul (KR); Tae In Hyon, Gyeonggi-do (KR); Young Soo Kim, Seoul (KR); Hyun Gi Ahn, Incheon (KR); Kwanghun Han, Gyeonggi-do (KR); Hyun Ho Choi, Gyeonggi-do (KR); Hyewon Lee, Gyeonggi-do (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/034,125

(22) Filed: Feb. 20, 2008

(30) Foreign Application Priority Data
Sep. 20, 2007 (KR) 10-2007-0095968

(51) Int. Cl. H04B 7/005

(52) U.S. Cl. 455/522

(57) ABSTRACT

A cognitive radio terminal device. The cognitive radio terminal device comprises an available radio resource determination unit to determine an available radio resource from among up-link radio resources assigned to an up-link communication in a primary network, and an ad hoc communication performing unit to perform an ad hoc communication in a secondary network by using the available radio resource.

### CROSS-REFERENCE TO RELATED APPLICATION

This application claims the benefit of Korean Patent Application No. 2007-95968, filed in the Korean Intellectual Property Office on Sep. 20, 2007, the disclosure of which is incorporated herein by reference.

### BACKGROUND OF THE INVENTION

1. Field of the Invention

Aspects of the present invention relate to a cognitive radio terminal device and a method of communicating using the cognitive radio in which communication is performed using a part or all of a limited radio resource.

2. Description of the Related Art

As demands for communication services of high speed and high quality increase, radio resources capable of being used for the communication services are becoming scarce. For example, while frequency resources with superior communication efficiency are limited, communication services intending to use the frequency resources are continuing to increase. Accordingly, cognitive radio technologies that more effectively use the radio resources have been actively studied.

Current communication terminals emphasize mobility. A user's communication terminal is required to transmit/receive data with another communication terminal without any constraint while the user is moving. Accordingly, an ad hoc communication technology using an ad hoc network structure, which is autonomously composed of nodes and does not have a demand for a base network (such as an access point), has been rapidly developed. It may be more effective for a cognitive radio terminal device using a cognitive radio technology to perform a communication by forming a network with a communication terminal, such as another cognitive radio terminal device, or a mobile terminal device.

Currently, the cognitive radio terminal device is required to effectively select a radio resource. It is preferable for the cognitive radio terminal device to select a part or the whole part of radio resources of another communication system, so that the other communication system is not influenced significantly. Thus, there arises a need for a cognitive radio terminal device and a method of communication using the cognitive radio, in which radio resources assigned to surrounding communication systems are effectively selected and used in a range that does not exert influence on the communication systems.

### SUMMARY OF THE INVENTION

Aspects of the present invention provide a cognitive radio terminal device and a cognitive radio communication method in which an ad hoc communication is performed in a range where influence is not exerted on nodes included in a primary network, using a part or all of up-link radio resources of the primary network.

Additional aspects of the present invention provide a cognitive radio terminal device and a cognitive radio communication method in which a power of a transmission signal is controlled based on interference generated in a base station of a primary network, thereby minimizing influence exerted on an up-link communication of the primary network.

Additional aspects of the present invention provide a cognitive radio terminal device and a cognitive radio communication method in which a power of a transmission signal is effectively controlled regardless of a duplex type of a primary network, using a message exchange system and a message non-exchange system.

Additional aspects of the present invention provide a cognitive radio terminal device and a method using the cognitive radio in which an available radio resource is adaptively updated based on interference generated due to a terminal included in a primary network, thereby more effectively selecting a radio resource.

Additional aspects of the present invention provide a cognitive radio terminal device and a method using the cognitive radio in which a limited radio resource is effectively assigned and used, thereby increasing efficiency of radio resource.

According to an aspect of the present invention, a cognitive radio terminal device is provided. The cognitive radio terminal device comprises an available radio resource determination unit to determine an available radio resource from among up-link radio resources assigned to an up-link communication in a primary network; and an ad hoc communication performing unit to perform an ad hoc communication in a secondary network by using the available radio resource.

According to another aspect of the present invention, the cognitive radio terminal device further comprises a power control unit to control power of a transmission signal based on interference generated in a base station included in the primary network, and the ad hoc communication performing unit performs the ad hoc communication according to the controlled power.

According to another aspect of the present invention, the power control unit transmits a power control message to the base station, and controls the power of the transmission signal based on whether a power response message corresponding to the power control message is received from the base station.

According to another aspect of the present invention, the power control unit calculates an amount of attenuation of a beacon signal transmitted from the base station, and controls the power of the transmission signal according to the amount of attenuation.

According to another aspect of the present invention, the ad hoc communication performing unit updates the available radio resource based on interference generated by a terminal included in the primary network, and performs the ad hoc communication using the updated available radio resource.

According to another aspect of the present invention, the available radio resource determination unit determines the available radio resource from among the up-link radio resources using MAP information of the primary network.

According to another aspect of the present invention, the available radio resource determination unit determines the radio resource assigned to the terminal included in the primary network as the available radio resource when a power of a signal transmitted from the terminal is lower than a predetermined level.

According to another aspect of the present invention, a cognitive radio communication method is provided. The method comprises determining an available radio resource from among up-link radio resources assigned to an up-link communication in a primary network; and performing an ad hoc communication in a secondary network using the available radio resource.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a secondary network where a primary network performs a down-link communication, according to an embodiment of the present invention;

FIG. 2 is a diagram illustrating a secondary network where a primary network performs an up-link communication, according to an embodiment of the present invention;

FIG. 3 is a block diagram illustrating a cognitive radio terminal device according to an embodiment of the present invention;

FIG. 4 is a diagram illustrating an example of a message flow where power of a transmission signal is controlled by a message exchange system, according to an embodiment of the present invention;

FIG. 5 is a diagram illustrating a magnitude of a power of a transmission signal corresponding to each message where a power of the transmission signal is controlled according to the message flow of FIG. 4; and

FIG. 6 is a flowchart illustrating a cognitive radio communication process according to an embodiment of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

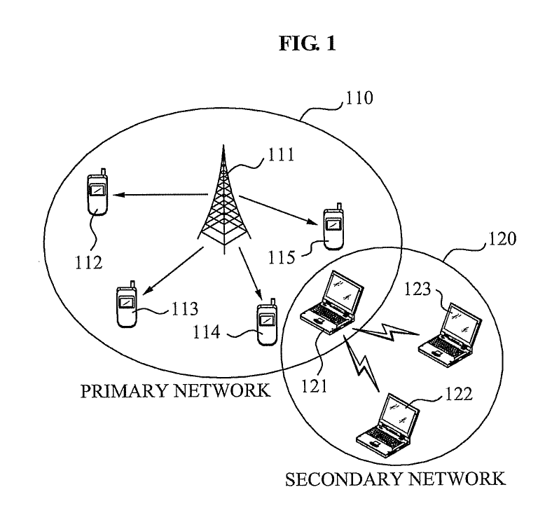

FIG. 1 shows a secondary network where a primary network 110 performs a down-link communication, according to an embodiment of the present invention. As shown in FIG. 1, the primary network 110 includes a base station 111 and terminals 112, 113, 114, and 115. When a down-link communication is performed in the primary network 110, the base station 111 transmits signals to the terminals 112, 113, 114, and 115. The base station 110 may transmit signals to the terminals 112, 113, 114, and 115 using any one of a unicast scheme, a multicast scheme, and a broadcast scheme.

A secondary network 120 includes terminals 121, 122, and 123. The terminals 121, 122, and 123 may perform an ad hoc communication with each other using cognitive radio technologies. The terminals in the secondary network 120, such as the terminal 121, may perform an ad hoc communication with other terminals 122 and 123 using a part or all of radio resources assigned to the primary network 110.

In one example, the down-link communication is performed in the primary network 110, and the terminals 114 and 115 receive signals from the base station 111. When an ad hoc communication is performed in the secondary network 120, the terminals 114 and 115 may have interference generated due to signals transmitted to the terminal 121 of the secondary network 120. The terminals 114 and 115 receive signals transmitted from the base station 111, and also receive signals transmitted from the terminal 121. Accordingly, signals transmitted from the terminal 121 may be a cause of the interference generated in the terminals 114 and 115. Thus, when performing down-link communication in the primary network 110, when the terminal 121 performs an ad hoc communication in the secondary network 120 using radio resources assigned to the primary network 110, interference generated in the terminals 112, 113, 114, and 115 included in the primary network 110 may increase.

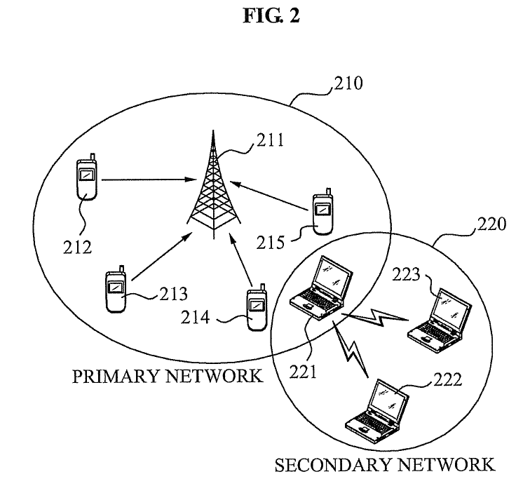

FIG. 2 shows a secondary network 220 where a primary network 210 performs an up-link communication. As shown in FIG. 2, the primary network 210 includes a base station 211 and terminals 212, 213, 214, and 215. The secondary network 220 includes terminals 221, 222, and 223.

An up-link communication is performed in the primary network 210. The terminals 212, 213, 214, and 215 transmit signals to the base station 211, and the terminals 221, 222, and 223 perform an ad hoc communication in the secondary network 222. When an up-link communication is performed in the primary network 210, the base station 211 receives signals from the terminals 212, 213, 214, and 215. The terminals 221, 222, and 223 performing the ad hoc communication in the secondary network 220 transmit and receive signals with one other. The terminals 214 and 215 may receive signals transmitted from the terminals 221, 222, and 223.

As discussed above, when an up-link communication is performed in the primary network 210, each of the terminals 212, 213, 214, and 215 included in the primary network acts as a transmitter, and the base station 211 acts as a receiver. Accordingly, even when the terminals 214 and 215 receive signals transmitted from the terminals 221, 222, and 223, the terminals 214 and 215 may perform the up-link communication normally. As a result, when an up-link communication is performed in the primary network 210, even when the terminals 221, 222, and 223 included in the secondary network 220 perform an ad hoc communication using radio resources assigned to the primary network 210, this ad hoc communication does not influence normal operation of the terminals 212, 213, 214, and 215 significantly.

Accordingly, the case where each of the terminals 221, 222, and 223 of the secondary network 220 uses radio resources assigned to the up-link communication in the primary network 210 is more effective than the case where each of the terminals 221, 222, and 223 of the secondary network 220 uses radio resources assigned to the down-link communication in the primary network 210. However, when an up-link communication is performed in the primary network 210, the base station 211 may have interference generated due to signals transmitted from the terminals 221, 222, and 223 of the secondary network 220. In this instance, each of the terminals 221, 222, and 223 of the secondary network 220 controls the power of transmission signals, thereby reducing interference generated in the base station 211. As a result, the base station 211 operates normally.

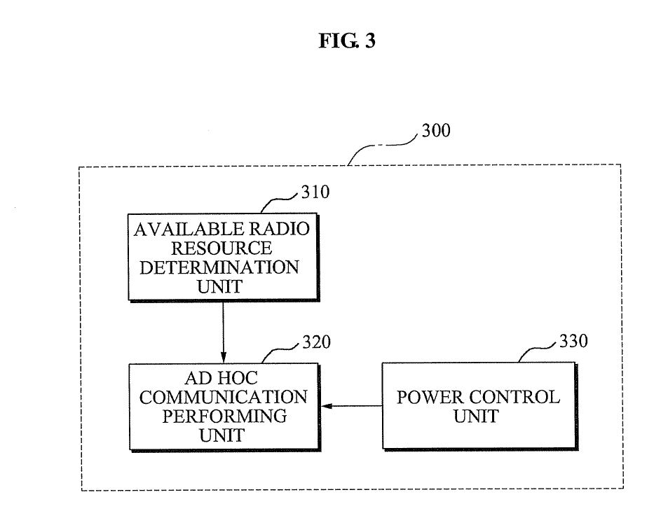

FIG. 3 shows a cognitive radio terminal device 300 according to an embodiment of the invention. The cognitive radio terminal device 300 includes an available radio resource determination unit 310, an ad hoc communication performing unit 320, and a power control unit 330. According to other aspects of the invention, the cognitive radio terminal device may include additional and/or different units. Similarly, the functionality of two or more of the above units may be combined into a single component. The cognitive radio terminal device 300 may be any device that transmits or receives data wirelessly, such as a mobile phone, personal digital assistant, or personal entertainment device.

The available radio resource determination unit 310 determines available radio resources from among up-link radio resources assigned to an up-link communication in a primary network. The radio resources may include frequency resources, time resources, code resources, or space resources. The available radio resource determination unit 310 determines a part or all of the radio resources assigned to the primary network as an available radio resource while performing an up-link communication in the primary network, thereby minimizing influences exerted on the terminals performing a communication in the primary network.

The available radio resource determination unit 310 may verify a data frame structure of the primary network, and determine available radio resources using MAP (mobile application part) information included in a data frame. When each of the terminals included in the primary network performs an up-link communication, the MAP information may include scheduling information with respect to radio resources assigned to the terminals of the primary network. The available radio resource determination unit 310 may determine an unused radio resource in the up-link radio resources of the primary network as an available radio resource using the scheduling information. When the power of signals transmitted from a terminal included in the primary network is lower than a predetermined level, the available radio resource determination unit 310 may determine a radio resource assigned to the terminal included in the primary network as an available radio resource.

In one example, terminals A and B are present in the primary network, each of terminals A and B performs an up-link communication, and radio resources X and Y are assigned to terminals A and B, respectively. When the power of signals transmitted from terminal A is lower than a predetermined level, the available radio resource determination unit 310 may determine that a distance between the cognitive radio terminal device 300 and terminal A is relatively great. In this case, even though the cognitive radio terminal device 300 uses radio resource X assigned to terminal A, the communication performance of terminal A is not influenced significantly. Accordingly, the available radio resource determination unit 310 may determine radio resource X assigned to terminal A as an available radio resource of the cognitive radio terminal device 300. Thus, the available radio resource determination unit 310 may determine, from among up-link communication resources of the primary network, a radio resource which is not assigned to terminals included in the primary network, and/or a radio resource which is assigned to terminals included in the primary network located far from the cognitive radio terminal device 300, as an available radio resource.

The ad hoc communication performing unit 320 performs an ad hoc communication in the secondary network using the radio resources determined as the available radio resource by the available radio resource determination unit 310. Accordingly, communication operation performed in the primary network is not influenced, and the cognitive radio terminal device 300 may perform an ad hoc communication with another cognitive radio terminal device or another communication terminal in the secondary network using a part or all of the radio resources assigned to the primary network.

The ad hoc communication performing unit 320 may update available radio resources determined by the available radio resource determination unit 310 based on interference generated due to terminals included in the primary network, and may perform an ad hoc communication using the updated available radio resource. When the interference generated due to the terminals included in the primary network is higher than a predetermined level, the ad hoc communication performing unit 320 updates available radio resources so as to exclude radio resources assigned to the terminals included in the primary network, and performs the ad hoc communication.

For example, when the cognitive radio terminal device 300 performs an ad hoc communication using radio resource X, terminal A included in the primary network may perform an up-link communication. In this instance, the cognitive radio terminal device 300 may calculate an interference level generated due to signals transmitted from terminal A. When the interference level is higher than a predetermined level, the cognitive radio terminal device 300 may determine terminal A as a terminal that is a potential cause of the interference.

If radio resource X is later assigned to terminal A, problems could arise due to the cognitive radio terminal device 300 while terminal A performs a communication in the primary network. Accordingly, when radio resource X is later assigned to terminal A, the ad hoc communication performing unit 320 may update available radio resources so as to change from radio resource X to radio resource Y, and may perform an ad hoc communication using radio resource Y.

The power control unit 330 controls the power of transmission signals of the cognitive radio terminal device 300 based on interference generated in the base station included in the primary network. The power control unit 330 may control the power of the transmission signals using a message exchange system and/or a message non-exchange system.

The message exchange system may be used where a message exchange between the base station included in the primary network and the cognitive radio terminal device 300 is possible. The power control unit 330 may transmit a power control message to the base station. A power of the power control message is incrementally increased with subsequent transmission. The power control unit 330 may control the power of the transmission signals depending upon whether a power response message corresponding to the power control message is received from the base station.

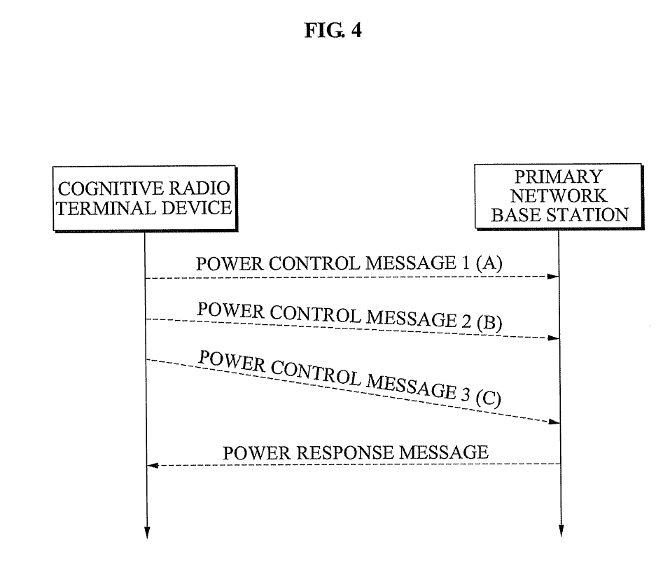

In an example shown in FIG. 4, power control messages 1, 2, and 3 are present. The power of each power control message 1, 2, and 3 is greater than the power of the preceding messages. In this instance, the power control unit 330 transmits the power control messages 1, 2, and 3 to the base station until a power response message is received from the base station. The base station calculates interference level generated in the base station due to the power control messages 1, 2, and 3, and predicts a maximum threshold power capable of being acquired by a transmission signal of the cognitive radio terminal device.

As shown in FIG. 4, if the power C of the power control message 3 is greater than the maximum threshold power and the power B of the power control message 2 is less than the maximum threshold power, he base station transmits a power response message corresponding to the power control message 3 to the cognitive radio terminal device 300. The power control unit 330 controls a power of the transmission signal using a power greater than the power B and less than the power C.

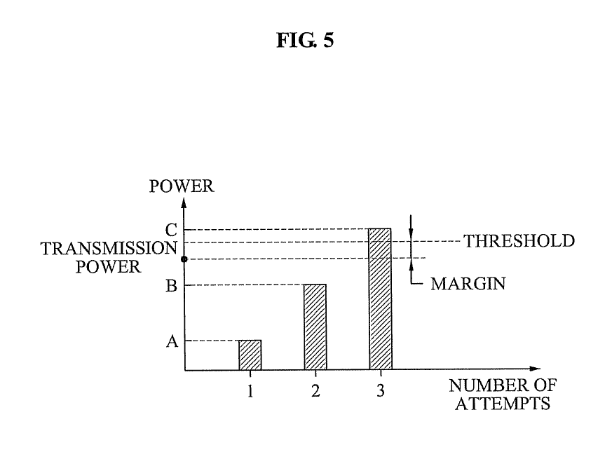

Hereinafter, the message exchange system according to an embodiment of the present invention will be described in detail with reference to FIGS. 4 and 5. The message exchange system may be used where the cognitive radio terminal device 300 cannot exchange messages with the base station or terminals included in the primary network. For example, the base station transmits a beacon signal including power information of the transmission signal to the cognitive radio terminal device 300. The cognitive radio terminal device 300 may calculate an amount of attenuation of a beacon signal generated in a path from the base station to the cognitive radio terminal device 300. The power control unit 330 may predict interference capable of being generated in the base station based on the amount of the attenuation of the beacon signal, and control the power of the transmission signal accordingly. The message exchange system may be used more effectively in a time division duplexing (TDD) channel where an up-link channel status and a down-link channel status are almost equivalent.

FIG. 4 shows an example of a message flow where power of a transmission signal is controlled by a message exchange system according to an embodiment of the present invention. FIG. 5 shows a magnitude of power of a transmission signal corresponding to each message where power of the transmission signal is controlled according to the message flow of FIG. 4.

As shown in FIG. 4, the cognitive radio terminal device 300 sequentially transmits power control messages 1, 2, and 3 to a base station of a primary network. In this instance, the power of the power control messages 1, 2, and 3 is A, B, and C, respectively. The base station predicts a threshold of a power capable of being acquired by a transmission signal of the cognitive radio terminal device. Since the power A and B of the power control messages 1 and 2 is less than the threshold, the base station does not transmit a power response message in response to power control messages 1 and 2.

However, when the cognitive radio terminal device 300 transmits power control message 3, the base station determines that the power C of the power control message 3 is greater than the threshold, and transmits a power response message to the cognitive radio terminal device. In The cognitive radio terminal device 300 determines a power of the transmission signal of the cognitive radio terminal device providing a predetermined margin.

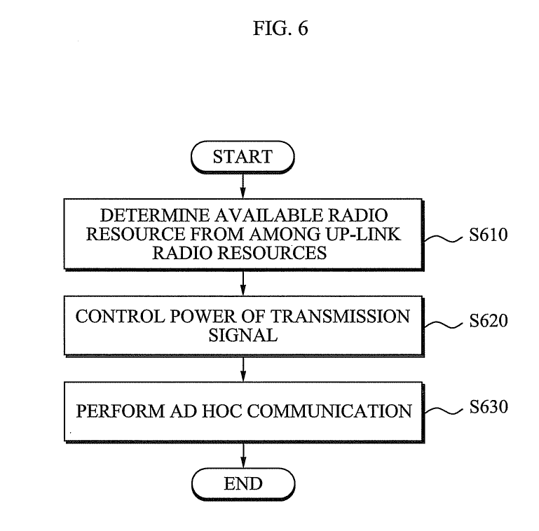

FIG. 6 is a flowchart of a cognitive radio communication process according to an embodiment of the invention. In operation S610, the cognitive radio terminal device 300 determines available radio resources from among up-link radio resources assigned to an up-link communication in a primary network.

The cognitive radio terminal device 300 may determine the available radio resources are determined from among the up-link radio resources using MAP information of the primary network. The cognitive radio terminal device 300 may also determine unused radio resources in the up-link radio resources as the available radio, using the MAP information of the primary network. When a power of a signal transmitted from a terminal included in the primary network is lower than a predetermined level, radio resources assigned to the terminal included in the primary network may be determined as the available radio resources. The techniques described are not limiting; the cognitive radio terminal device 300 may determine the available radio resource using these techniques or other techniques.

In operation S620, the cognitive radio terminal device 300 controls a power of a transmission signal based on interference generated in a base station included in the primary network.

A power control message may be transmitted to the base station. The power of the transmission signal is controlled depending upon whether a power response message corresponding to the power control message is received from the base station. Alternatively, an amount of attenuation of a beacon signal transmitted from the base station is calculated, and the power of the transmission signal is controlled according to the amount of the attenuation.

The power of the transmission signal may also be controlled using either a message exchange system for controlling the power of the transmission signal by exchanging a message with the base station, or a message non-exchange system for controlling the power of the transmission signal according to the amount of attenuation of the beacon signal transmitted from the base station, as described above.

In operation S630, the cognitive radio terminal device 300 performs an ad hoc communication in a secondary network using the available radio resources. The cognitive radio terminal device 300 may perform an ad hoc communication according to a power of the controlled transmission signal. The cognitive radio terminal device 300 may also update the available radio resources based on interference generated due to a terminal included in the primary network, and perform the ad hoc communication using the updated available radio resources.

The cognitive radio communication method according to aspects of the present invention may be recorded in computer-readable media including program instructions to implement various operations embodied by a computer. The media may include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media, such as hard disks, floppy disks, and magnetic tape; optical media, such as CD ROM disks and DVDs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of embodiments of the present invention.

According to aspects of the present invention, an ad hoc communication may be performed in a range where influence is not exerted on nodes included in a primary network by using a part or all of up-link radio resources of the primary network.

According to additional aspects of the present invention, a power of a transmission signal may be controlled based on interference generated in a base station of a primary network, thereby minimizing influence exerted on an up-link communication of the primary network.

According to additional aspects of the present invention, a power of a transmission signal may be effectively controlled regardless of a duplex type of a primary network using a message exchange system and a message non-exchange system.

According to additional aspects of the present invention, an available radio resource may be adaptively updated based on interference generated due to a terminal included in a primary network, thereby more effectively selecting a radio resource.

According to additional aspects of the present invention, a limited radio resource may be effectively assigned and used, thereby increasing efficiency of radio resources.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A cognitive radio terminal device, comprising:
an available radio resource determination unit to determine an available radio resource from among up-link radio resources assigned to an up-link communication in a primary network; and
an ad hoc communication performing unit to perform an ad hoc communication in a secondary network using the available radio resource.

2. The device of claim 1, further comprising:
a power control unit to control power of a transmission signal based on interference generated in a base station included in the primary network;
wherein the ad hoc communication performing unit performs the ad hoc communication according to the controlled power.

3. The device of claim 2, wherein the power control unit transmits a power control message to the base station, and controls the power of the transmission signal based on whether a power response message corresponding to the power control message is received from the base station.

4. The device of claim 2, wherein the power control unit calculates an amount of attenuation of a beacon signal transmitted from the base station, and controls the power of the transmission signal according to the amount of attenuation.

5. The device of claim 2, wherein the power control unit controls the power of the transmission signal using a message exchange system to control the power of the transmission signal by exchanging a message with the base station, or using a message non-exchange system to control the power of the transmission signal according to an amount of attenuation of a beacon signal transmitted from the base station.

6. The device of claim 1, wherein the ad hoc communication performing unit updates the available radio resource based on interference generated by a terminal included in the primary network, and performs the ad hoc communication using the updated available radio resource.

7. The device of claim 6, wherein the ad hoc communication performing unit updates the available radio resource so as to exclude a radio resource assigned to the terminal when the interference generated by the terminal is greater than a predetermined level, and performs the ad hoc communication using the updated available radio resource.

8. The device of claim 1, wherein the available radio resource determination unit determines the available radio resource from among the up-link radio resources using MAP (mobile application part) information of the primary network.

9. The device of claim 1, wherein the available radio resource determination unit determines an unused radio resource in the up-link radio resources as the available radio resource using MAP information of the primary network.

10. The device of claim 1, wherein the available radio resource determination unit determines the radio resource assigned to the terminal included in the primary network as the available radio resource when a power of a signal transmitted from the terminal is lower than a predetermined level.

11. The device of claim 1, wherein the available radio resource includes at least one of a frequency resource, a time resource, a code resource, and/or a space resource.

12. A cognitive radio communication method, comprising:
determining an available radio resource from among up-link radio resources assigned to an up-link communication in a primary network; and
performing an ad hoc communication in a secondary network using the available radio resource.

13. The method of claim 12, further comprising:
controlling a power of a transmission signal based on interference generated in a base station included in the primary network;
wherein the performing comprises performing the ad hoc communication according to the controlled power.

14. The method of claim 13, wherein the controlling of the power comprises:
transmitting a power control message to the base station; and
controlling the power of the transmission signal based on whether a power response message corresponding to the power control message is received from the base station.

15. The method of claim 13, wherein the controlling of the power comprises:
calculating an amount of attenuation of a beacon signal transmitted from the base station; and
controlling the power of the transmission signal according to the amount of the attenuation.

16. The method of claim 13, wherein the controlling of the power comprises controlling the power of the transmission signal using a message exchange system to control the power of the transmission signal by exchanging a message with the base station, or using a message non-exchange system to control the power of the transmission signal according to an amount of attenuation of a beacon signal transmitted from the base station.

17. The method of claim 12, wherein the performing of the ad hoc communication comprises:
updating the available radio resource based on interference generated by a terminal included in the primary network; and
performing the ad hoc communication using the updated available radio resource.

18. The method of claim 12, wherein the determining of the available radio resource comprises determining the available radio resource from among the up-link radio resources using MAP information of the primary network.

19. The method of claim 12, wherein the determining of the available radio resource comprises determining an unused radio resource in the up-link radio resources as the available radio resource using MAP (mobile application part) information of the primary network.

20. The method of claim 12, wherein the determining of the available radio resource comprises determining the radio resource assigned to the terminal included in the primary network as the available radio resource when a power of a signal transmitted from the terminal is lower than a predetermined level.

21. A computer-readable recording medium storing a program to implement the method of claim 12.

22. The method of claim 14, wherein the transmitting of the power control message comprises transmitting a sequence of power control messages to the base station, the first power control message having a predetermined power and each subsequent power control message having a power greater than the preceding power control message, until a response is received from the base station.

23. The method of claim 19, wherein the MAP information comprises scheduling information about the radio resources.

24. A system comprising:
a primary network including a base station and a first plurality of terminals; and
a secondary network including a second plurality of terminals;
wherein each of the second plurality of terminals determines an available radio resource from among up-link radio resources assigned to an up-link communication in the primary network, and performs ad-hoc communication in the secondary network using the available radio resource.

25. The system of claim 24, wherein each of the second plurality of terminals determines a power of a transmission signal based on interference generated by the base station, and performs the ad-hoc communication based on the power.

26. The system of claim 25, wherein each of the second plurality of terminals transmits a sequence of power control messages to the base station, the first power control message having a predetermined power and each subsequent power control message having a power greater than the preceding power control message, until a response is received from the base station; and controls the power of the transmission signal based on a power of the power control message that resulted in the response.

27. The system of claim 25, wherein each of the second plurality of terminals calculates an attenuation of a beacon signal transmitted from the base station, and controls the power of the transmission signal based on the attenuation.

28. The system of claim 24, wherein each of the second plurality of terminals updates the available radio resource based on interference generated by one of the first plurality of terminals, and performs the ad hoc communication using the updated available radio resource.

29. The system of claim 24, wherein each of the second plurality of terminals determines the available radio resource as a radio resource assigned to one of the first plurality of terminals when a power of a signal transmitted from the one of the first plurality of terminals is less than a predetermined level.

30. The system of claim 24, wherein each of the second plurality of terminals determines a distance from one of the first plurality of terminals, and determines the available radio resource as a radio resource assigned to the one of the first plurality of terminals if the distance is greater than a predetermined distance.
